(19) United States
(12) Patent Application Publication
(10) Pub. No.: US 2022/0067280 A1
(43) Pub. Date: Mar. 3, 2022

(54) MULTI-TOKEN EMBEDDING AND CLASSIFIER FOR MASKED LANGUAGE MODELS

(71) Applicant: Microsoft Technology Licensing, LLC, Redmond, WA (US)

(72) Inventors: Andy Wagner, Cupertino, CA (US); Tiyasa Mitra, San Jose, CA (US); Marc Tremblay, Bellevue, WA (US)

(21) Appl. No.: 17/002,407

(22) Filed: Aug. 25, 2020

(51) Int. Cl. G06F 40/284; G06N 3/08; G06F 40/30

(52) U.S. Cl. CPC G06F 40/284; G06F 40/30; G06N 3/08

(57) ABSTRACT

Embodiments of the present disclosure include systems and methods for training transformer models. In some embodiments, a set of input data are received. The input data comprises a plurality of tokens including masked tokens. The plurality of tokens in an embedding layer are processed. The embedding layer is coupled to a transformer layer. The plurality of tokens are processed in the transformer layer, which is coupled to a classifier layer. The plurality of tokens are processed in the classifier layer. The classifier layer is coupled to a loss layer. At least one of the embedding layer and the classifier layer combine masked tokens at a current position with tokens at one or more of a previous position and a subsequent position.

### BACKGROUND

The present disclosure relates to a computing system. More particularly, the present disclosure relates to techniques for training a neural network.

Natural-language understanding (NLU) is a subfield of natural-language processing (NLP) in artificial intelligence that addresses comprehension by computers of the structure and meaning of human language. NLU enables voice technology, search engines, and machine translation to deduce what a user means, regardless of the way it is expressed

A neural network is a machine learning model that underpins NLU applications. A neural network is trained for a particular purpose by running datasets through it, comparing results from the neural network to known results, and updating the network based on the differences.

### BRIEF DESCRIPTION OF THE DRAWINGS

Various embodiments of the present disclosure are illustrated by way of example and not limitation in the figures of the accompanying drawings.

FIG. 1 illustrates a system for training a transformer model according to some embodiments.

FIG. 2 illustrates an architecture of the input data processor illustrated in FIG. 1 according to some embodiments.

FIG. 3 illustrates an example sequence of tokens according to some embodiments.

FIG. 4 illustrates another architecture of the input data processor illustrated in FIG. 2 according to some embodiments.

FIG. 5 illustrates another example sequence of tokens according to another embodiment.

FIG. 6 illustrates an architecture of the output data processor illustrated in FIG. 1 according to some embodiments.

FIG. 7 illustrates an architecture of the masked token manager illustrated in FIG. 6 according to some embodiments.

FIG. 8 illustrates a process for multi-token embedding according to some embodiments.

FIG. 9 depicts a simplified block diagram of an example computer system according to some embodiments.

FIG. 10 illustrates a neural network processing system according to some embodiments.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

Described here are techniques for including information about adjacent tokens at the embedding layer and/or the classifier layer of a neural network. In some embodiments, a system may receive input data for a transformer model. The input data can include a set of tokens (e.g., a set of words forming a sentence) in a sequence. For training purposes, a number of tokens are masked. In other words, information about the token is removed. The neural network may predict/guess what the masked token is.

At an embedding layer, each token may be mapped to a word in the neural network's vocabulary represented by a vector. The embedding layer may further map one or more adjacent tokens (e.g., tokens coming before and/or after the original token in a sequence) at the same time as the original token. The embedding layer may then combine the vectors. The output of the embedding layer is provided to a transformer layer which may determine correlations between tokens.

A classifier layer may gather the masked tokens from the output of the transformer layer. The classifier layer may further gather one or more tokens adjacent to the gathered masked token (e.g., tokens coming before and/or after the masked token in the sequence). The classifier layer may then combine the tokens. The masked token may be mapped back to the vocabulary to produce the prediction/guess for the masked token. For training purposes, the prediction/guess may be compared against the known token in the training data and the layers of the neural network updated to improve the neural network's predications/guesses.

The techniques described in the present application provide a number of benefits and advantages over conventional methods of embedding and/or classifying. For instance, embodiments of the present disclosure may use information in adjacent tokens in the embedding layer rather than just the individual tokens alone. The combination of the original token with the adjacent token(s) creates a joint probability for the tokens instead of an individual one. In other words, the probability space is expanded and the transformer neural network is provided with more information. By way of further example, embodiments of the present disclosure may use information in adjacent tokens in the classifier layer rather than the masked tokens by themselves. More information is used in the classifier layer to make the prediction/guess. The neural network's prediction/guess accuracy is better and the neural network converges faster with multiple tokens than when tokens are embedded and/or classified alone. Accordingly, training time of a neural network may be reduced (e.g., in an embedding layer, transformer layer, and/or classifier layer as described below).

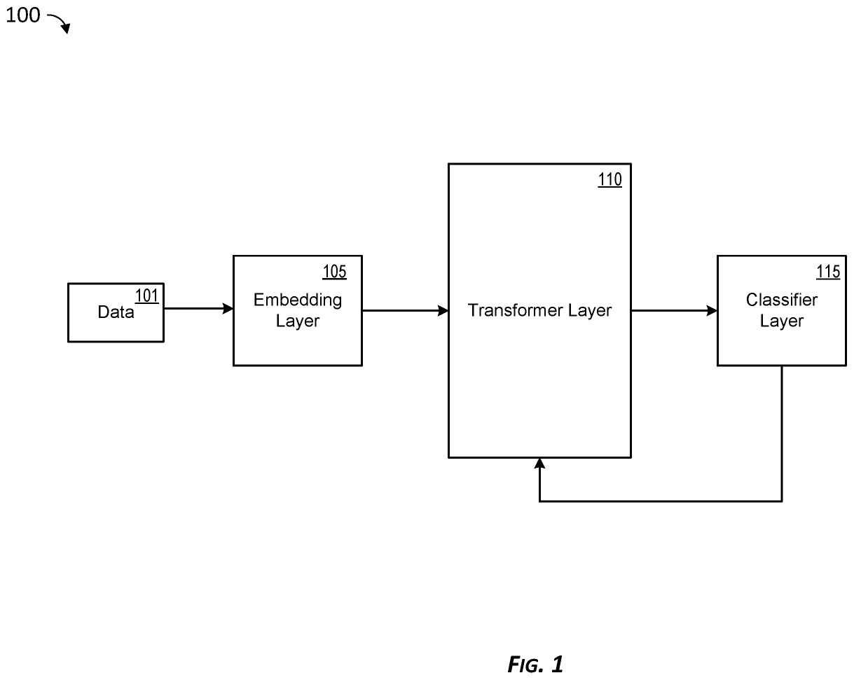

FIG. 1 illustrates system 100 for training a transformer model according to some embodiments. As shown, system 100 includes embedding layer 105, transformer layer 110, and classifier layer 115. Embedding layer 105 is configured to process input data 101 used for training transformer layer 110. For example, embedding layer 105 may receive a set of input data that includes a sequence of tokens (e.g., a set of words).

For example, if the sequence of tokens of the input data includes a set of words that form a sentence, embedding layer 105 may generate a set of training data that includes the set of words and a set of sequential position values for the set of words. In some embodiments, a position value represents the relative position of a particular token (e.g., word) in a sequence of tokens. Embedding layer 105 can determine a set of successive position values for a set of words by selecting a position value offset from a range of candidate position value offsets and using the position value offset as the first position value in the set of successive position values. For a given set of such input data, embedding layer 105 may generate different sets of training data that each includes the set of words and a different set of successive position values.

For instances where the sequence of tokens of the input data includes several sets of words the each form a sentence, embedding layer 105 may generate a set of training data that includes the several set of words and a set of successive position values for each set of words. In some cases, embedding layer 105 may use different position value offsets for some or all of the different sets of successive position values for the several set of words. In other cases, embedding layer 105 uses the same position value offset for some or all of the different sets of successive position values for the several set of words. For a given set of this input data, embedding layer 105 can generate different sets of training data that each includes the several sets of words and different sets of successive position values for the several sets of words.

In addition to position values, embedding layer 105 may include a set of sentence values in the set of training data. In some embodiments, a sentence value represents a sentence to which a token in the sequence of tokens belongs. Next, embedding layer 105 may select a defined number of tokens in the sequence of tokens or a defined portion of the sequence of tokens (e.g., a percentage of the total number tokens in the sequence). In some embodiments, embedding layer 105 selects tokens in the sequence randomly. Embedding layer 105 then replaces the selected tokens with a defined token value. The selection and replacement of tokens may also be referred to as token masking. The selected and replaced tokens are also known as masked tokens.

After masking tokens in the input data, embedding layer 105 may determine token embeddings for each unmasked token in the sequence of tokens using an embedding space generated from a corpus of tokens (e.g., a vocabulary of words). In some embodiments, a token embedding space maps tokens in the corpus, which has many dimensions, to numeric representations (e.g., vectors) having a lower number of dimensions. Then, embedding layer 105 can determine position embeddings for each unmasked position value in the set of position values using an embedding space generated from a corpus of position values. The range of values in the corpus of position values can be a maximum sequence length (e.g., a maximum number of tokens in a sequence) that transformer layer 110 is configured to process. For example, if transformer layer 110 is configured to process sequence lengths of 1024, the range of values in the corpus of position values may be 0 to 1023. In some embodiments, a position value embedding space maps position values in the corpus, which has many dimensions, to numeric representations (e.g., vectors) having a lower number of dimensions.

In cases where the training data includes sentence values, embedding layer 105 may determine sentence embeddings for each sentence value in the set of sentence values using an embedding space generated from a corpus of sentence values. In some embodiments, a sentence value embedding space maps sentence values in the corpus, which has many dimensions, to numeric representations (e.g., vectors) having a lower number of dimensions. After determining embeddings for tokens, position values, and/or sentence values, embedding layer 105 calculates an aggregate embedding for each token in the sequence of tokens by adding the token embedding, the corresponding position value embedding, and/or the corresponding sentence value embedding together. Finally, embedding layer 105 sends the aggregate embeddings to transformer layer 110 for training.

Transformer layer 110 is responsible for predicting masked tokens given training data that includes unmasked tokens and masked tokens. In some embodiments, transformer layer 110 is implemented by a transformer neural network (also referred to as a transformer or a transformer model). In some such embodiments, a transformer neural network has a sequence-to-sequence architecture. That is, the transformer neural network can transforms a given sequence of elements, such as the sequence of words in a sentence, into another sequence. In some embodiments, the transformer neural network includes weights used for predicting masked tokens and masked positions. The transformer neural network can adjust these weights based on feedback (e.g., differences between predicted tokens for masked tokens and actual values of masked tokens, etc.) received from classifier layer 115 using a back propagation technique.

Transformer layer 110 may determine relationships/correlations between tokens in input data. For instance, transformer layer 110 can process tokens in relation to all the other tokens in a sequence, instead of one-by-one in order. In other words, transformer layer 110 considers the full context of a token by looking at the tokens that come before and after it. Transformer layer 110 may be used for machine translation and search (e.g., conversational queries). Other applications of transformer layer 110 include: document summarization, document generation, named entity recognition (NER), speech recognition, and biological sequence analysis.

Classifier layer 115 is configured to process data output from transformer layer 110. For example, classifier layer 115 can receive an array of data from transformer layer 110 and label data. The array of data may include a numeric representation (e.g., the aggregate embedding described above) for each token in a sequence of tokens used as input to transformer layer 110. The label data may include values of masked tokens in the training data. Next, classifier layer 115 may identify the numeric representations of masked tokens in the array of data and determines the predicted tokens for the masked tokens. Classifier layer 115 then may determine the differences between the predicted tokens for masked tokens and the actual values of the masked tokens specified in the label data. Finally, classifier layer 115 may send the calculated differences back to transformer layer 110 to adjust the weights of transformer layer 110.

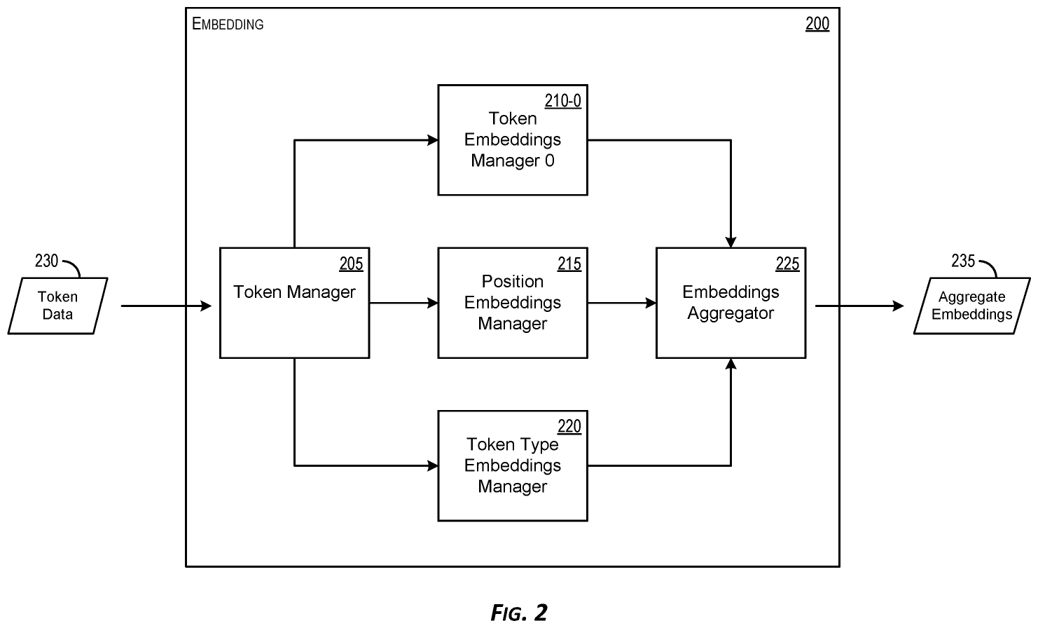

FIG. 2 illustrates an example architecture of embedding layer 200 according to some embodiments. As shown, embedding layer 200 includes token manager 205, token embeddings manager 210-0, position embeddings manager 215, token type embeddings manager 220, and embeddings aggregator 225. Token manager 205 is configured to generate sets of training data. As shown in FIG. 2, token manager 205 receives token data 230 as input data. For this example, token data 230 includes a sequence of tokens. In cases where the sequence of tokens of token data 230 includes a set of words that form a sentence, token manager 205 may generate a set of training data that includes the set of words and a set of successive position values for the set of words. Token manager 205 can determine a set of successive position values for a set of words by selecting a position value offset from a range of candidate position value offsets and using the position value offset as the first position value in the set of successive position values.

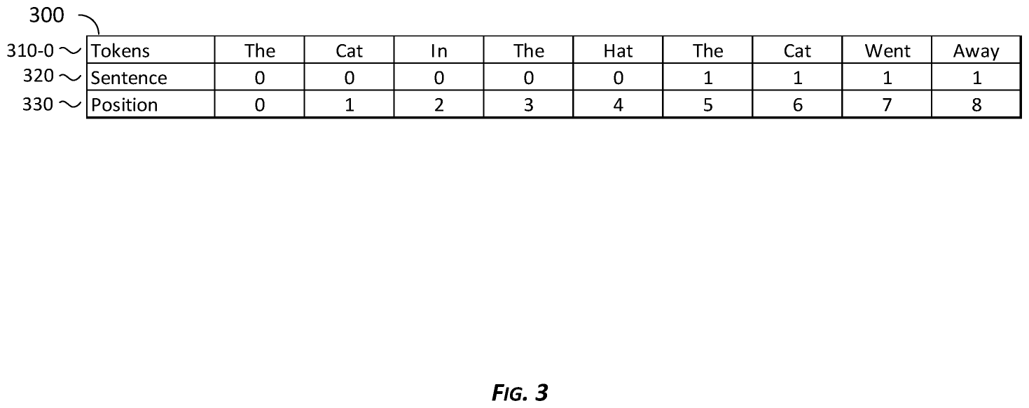

FIG. 3 illustrates an example of training data 300 with sentence and position values for a set of tokens according to some embodiments. In this example, a set of tokens is a set of words that form the sentences “The cat in the hat” and “The cat went away.” The set of tokens are included in the sequence of tokens of token data 230 for this example. When token manager 205 receives token data 230, token manager 205 selects a position value offset from a range of candidate position value offsets and uses the position value offset as the first position value in a set of successive position values. As mentioned above, transformer layer 110 may be configured to process a maximum sequence length (e.g., the maximum number of tokens in a sequence).

In some embodiments, the range of candidate position value offsets from which token manager 205 selects is determined based on the token length of a set of tokens for which a set of successive position values is being determined and the maximum sequence length so that each position value in a set of successive position values does not exceed the maximum sequence length. For example, using the token length of the set of tokens in this example and a maximum sequence length of 1024, the range of candidate position values in this example can be 0 to 1019. If 1019 is selected as the position value offset, the position value for the first token “The” would be 1019, the position value for the second token “Cat” would be 1020, the position value for the third token “In” would be 1021, the position value for the fourth token “The” would be 1022, and the position value for the fifth token “Hat” would be 1023. As such, all of the position values in the set of successive position values would be less than the maximum sequence length of 1024.

As explained above, from the position value offset, token manager 205 can determine the rest of the position values in the set of successive position values for the set of tokens. Here, token manager 205 selected the value 0 as the position value offset. Thus, as shown in FIG. 3, the position value for the first token “The” is 0, the position value for the second token “Cat” is 1, the position value for the third token “In” is 2, the position value for the fourth token “The” is 3, the position value for the fifth token “Hat” is 4, the position value for the sixth token “The” is 5, the position value for the seventh token “Cat” is 6, the position value for the eighth token “Went” is 7,and the position value for the ninth token “Away” is 8.

After determining the set of successive position values for the set of tokens, token manager 205 generates training data 300. As shown, training data 300 includes tokens 310-0, position values 330, and sentence values 320. Tokens 310-0 include the tokens used in this example. Position values 330 include the set of successive position values that token manager 205 determined for this example. Sentence values 320 include the value of 0 and 1, because token manager 205 determined that the set of words form a two sentences.

Returning to FIG. 2, token manager 205 can generate different sets of training data for a given set of input data. For input data that includes a set of words that form a sentence, each set of training data includes the set of words and a different set of successive position values. In some embodiments, token manager 205 iteratively selects position value offsets from the range of candidate position value offsets at fixed increments. For example, token manager 205 can select the smallest value from the range of candidate position value offsets for a first set of training data, incrementing the smallest value by a defined value and using it for a second set of training data, incrementing the value used for the second set of training data by the defined value and using it for a third set of training data, and so on.

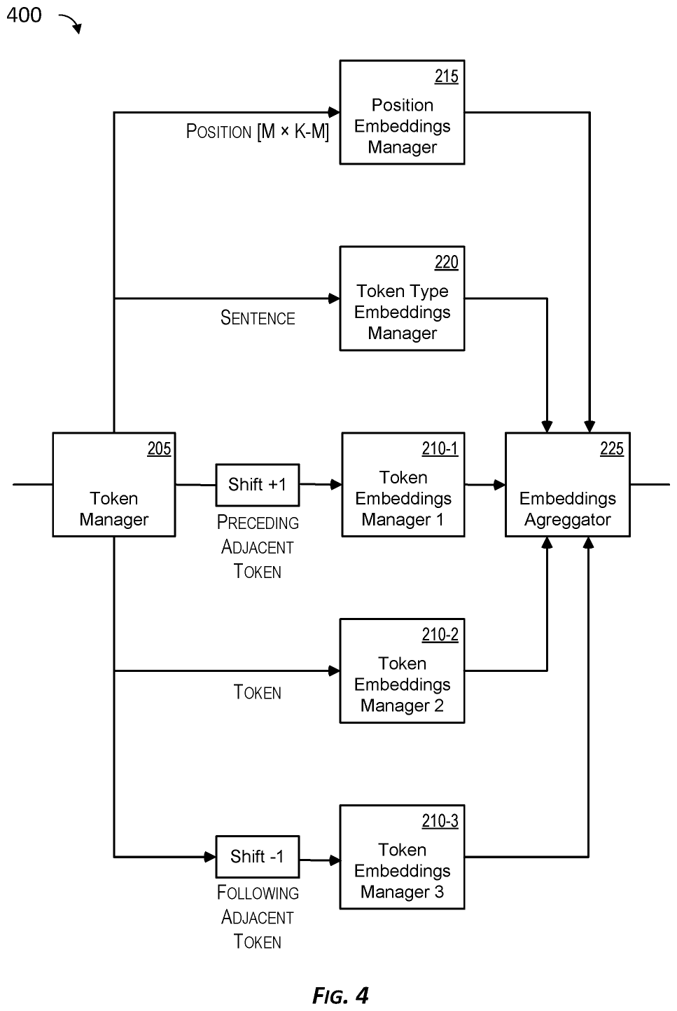

FIG. 4 illustrates another example architecture of an embedding layer 400 according to some embodiments. As shown, embedding layer 400 includes token manager 205, token embeddings managers 210-1 to 210-3, position embeddings manager 215, token type embeddings manager 220, and embeddings aggregator 225. Embedding layer 400 uses information in adjacent tokens in addition to individual tokens. Multiple token type embedding managers 210-1 and 210-3 provide information from the previous and next tokens.

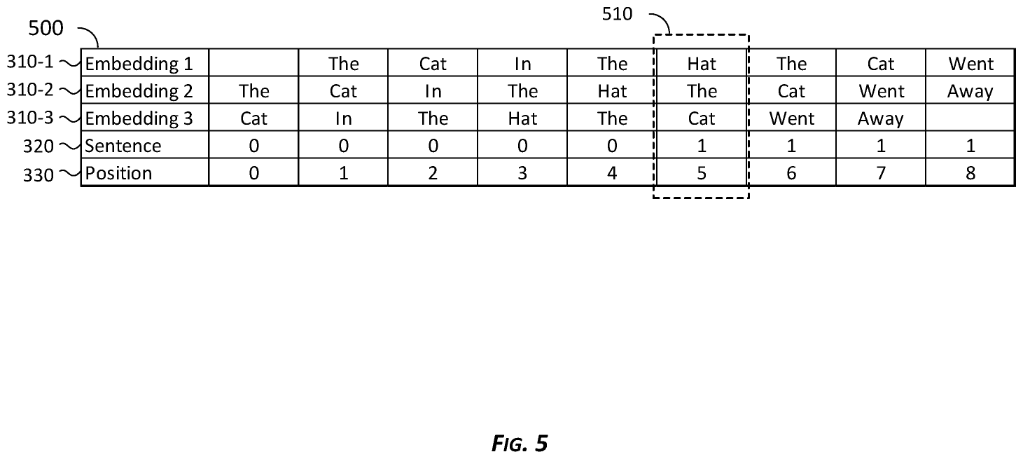

FIG. 5 illustrates the sequence of tokens 500 according to another embodiment. Sequence of tokens 500 shows the sentences “The cat in the hat” and “The cat went away” processed by embedding layer 400. A token in the embedding 2 310-2 row is the token being processed. Accordingly, the sentence 320 and position 330 values in the column apply to the token in embedding 2 310-2. The token in embedding 1 310-1 in a column is the preceding adjacent token to the token in embedding 2 310-2. The token in embedding 3 310-3 in a column is the following adjacent token to the token in embedding 2 310-2. For instance, example 510 shows the handling of the token “The” (position 5, sentence 2) in the sentence “The cat went away.” Token embeddings manager 2 210-2 processes the token “The,” where it is mapped to a vector as described above. The preceding adjacent token to “The”—“Hat”—is processed by token embeddings manager 210-1. The following adjacent token to “The”—“Cat”—is processed by token embeddings manager 210-3.

Although one preceding adjacent token and one following adjacent token are depicted in FIGS. 4 and 5, any number of preceding adjacent tokens and following adjacent tokens may be embedded. For example, two, three, four, etc. preceding adjacent tokens and following adjacent tokens may be embedded concurrently with the original token. Embedding layer 400 would have a token embeddings manager (e.g., token embeddings manager 1 210-1 or token embeddings manager 3 210-3) for each adjacent token embedded concurrently with the original token.

Token embeddings manager 1 210-1, token embeddings manager 2 210-2, and token embeddings manager 3 210-3 are each responsible for determining token embeddings for tokens. For example, upon receiving training data from token manager 205, Token embeddings manager 1 210-1, token embeddings manager 2 210-2, and token embeddings manager 3 210-3 convert each token in the training data to a numeric representation using an embedding space generated from a corpus of tokens. The numeric representation of a token can be a vector of 128, 256, 1024, 2048, 4096, etc. floating-point numbers. In some embodiments, the token embedding space may be implemented as a table with entries that map tokens to their corresponding numeric representations. To determine the numeric representation of a particular token in some such embodiments, token embeddings manager 1 210-1, token embeddings manager 2 210-2, and token embeddings manager 3 210-3 may perform a look up on the table to find an entry that matches the token and converts the token to the numeric representation specified by the entry. Once token embeddings manager 1 210-1, token embeddings manager 2 210-2, and token embeddings manager 3 210-3 determine numeric representations for each token in the training data, they send them to embeddings aggregator 225.

Position embeddings manager 215 is configured to determining position embeddings for position values. For instance, when position embeddings manager 215 receives training data from token manager 205, position embeddings manager 215 converts each position value in the training data to a numeric representation using an embedding space generated from a corpus of position values. The numeric representation of a position value may be a vector of 128, 256, 1024, 2048, 4096, etc. floating-point numbers.

In some embodiments, the position value embedding space is implemented as a table with entries that map position values to their corresponding numeric representations. To determine the numeric representation of a particular position value in some such embodiments, position embeddings manager 215 performs a look up on the table to find an entry that matches the position value and converts the position value to the numeric representation specified by the entry. After determining numeric representations for each position value in the training data, position embeddings manager 215 sends them to embeddings aggregator 225.

Token type embeddings manager 220 handles the determination of sentence embeddings for sentence values. For example, once token type embeddings manager 220 receives training data from token manager 205, token type embeddings manager 220 converts each sentence value in the training data to a numeric representation using an embedding space generated from a corpus of sentence values. The numeric representation of a sentence value can be a vector of 128, 256, 1024, 2048, 4096, etc. floating-point numbers. In some embodiments, the sentence value embedding space is implemented as a table with entries that map sentence values to their corresponding numeric representations. To determine the numeric representation of a particular sentence value in some such embodiments, token type embeddings manager 220 performs a look up on the table to find an entry that matches the sentence value and converts the sentence value to the numeric representation specified by the entry. Once token type embeddings manager 220 determines numeric representations for each sentence value in the training data, token type embeddings manager 220 sends them to embeddings aggregator 225.

Embeddings aggregator 225 is configured to calculate aggregate embeddings. For example, embeddings aggregator 225 may receive token embeddings from token embeddings manager 1 210-1, token embeddings manager 2 210-2, and token embeddings manager 3 210-3; position embeddings from position embeddings manager 215; and sentence embeddings from token type embeddings manager 220. Upon receiving the data from each of these components, embeddings aggregator 225 calculates an aggregate embedding for each token in the training data by adding the token embedding of the token, the token embedding of adjacent tokens, the position embedding associated with the token, and the sentence embedding associated with the token. Thus, the aggregate embedding for a token is a single numeric representation for the token, the position value associated with the token, and the sentence value associated with the token. Finally, embeddings aggregator 225 outputs the calculated aggregate embeddings as aggregate embeddings 235. In some embodiments, aggregate embeddings 235 is implemented in the form of an S×H array of vectors (e.g., a matrix). As such, the array may represent the sequence of tokens in token data 230 where the tokens are encoded representations of words, position values, and sentence values. For an S×H array, S can be the length (e.g., the total number of tokens) in a sequence of tokens and H can be the total number of numeric values in a vector used to represent a token. For example, if a token is represented using a vector of 1024 floating-point numbers, H is 1024.

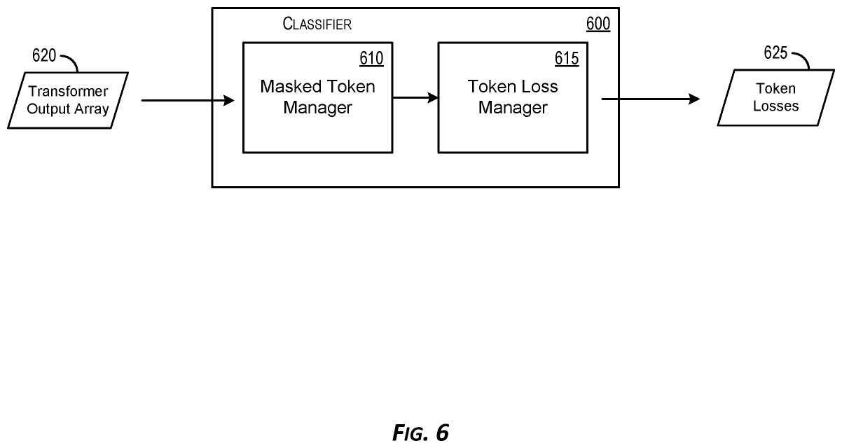

FIG. 6 illustrates an architecture of classifier layer 600 according to some embodiments. As shown, classifier layer 600 includes masked token manager 610, and token loss manager 615. As shown in FIG. 6, masked token manager 610 receives transformer output array 620 as input. In some embodiments, transformer output array 620 is implemented in the form of an S×H array of vectors (e.g. a matrix) similar to the S×H array used to implement aggregate embeddings 235 described above.

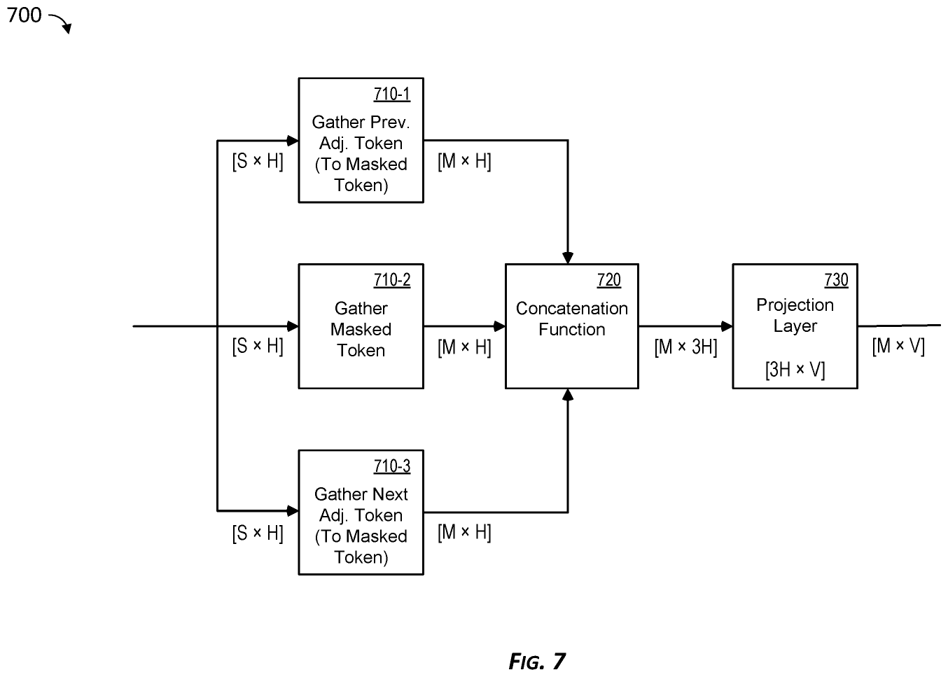

FIG. 7 illustrates a block diagram of masked token manager 610. Masked token manager 610 may include gather previous adjacent token 710-1, gather masked token 710-2, gather next adjacent token 710-3, concatenation function 710, and projection layer 730. Masked token manager 610 is configured to predict token for masked tokens. Gather masked token 710-2 may collect masked tokens from the S×H array of vectors (e.g. a matrix) from transformer module 110. Gather previous adjacent token 710-1 may collect the previous adjacent token to the masked token (gathered by gather masked token 710-2). Gather next adjacent token 710-3 may collect the next adjacent token to the masked token (gathered by gather masked token 710-2).

For instance, in the sentence “The cat in the hat,” the token “in” is masked and identified by gather masked token 710-2. The adjacent token preceding “in” is “cat.” “Cat” is identified by gather previous adjacent token 710-1. The adjacent token following “in” is “the.” “The” is identified by gather next adjacent token 710-3. Each of “cat,” “in,” and “the” (and tokens in the classification layer generally) may be implemented in the form of an M×H array of vectors. Concatenation function 720 concatenates the three M×H arrays of vectors (e.g., matrices) from gather previous adjacent token 710-1, gather masked token 710-2, and gather next adjacent token 710-3. Concatenation function 720 produces an M×3H array of vectors. In other words, the three matrices a placed side by side.

Projection layer 730 performs a set of projection functions on the vector representations to determine probabilities associated with corpus of tokens (e.g., a vocabulary of words) for each masked token. For each masked token, projection layer 730 selects the token having the highest probability as being the token predicted for the masked token. In some embodiments where the vector representations for the masked tokens are implemented in the form of an M×3H array, projection layer 730 multiplies the M×3H array by an 3H×V array to produce an M×V array. For the H×V array, V may be the size of a corpus of tokens and H can be the total number of numeric values in a vector used to represent each token in the corpus. The M×V array includes a vector of V values for each masked token. Each value in the vector represents a probability that a corresponding token in the corpus is the masked token. After predicting tokens for masked tokens, masked token manager 610 sends the predicted tokens to token loss manager 615.

Although two adjacent tokens are gathered in FIG. 7, masked token manager 610 may gather any number of previous adjacent tokens and next adjacent tokens. For instance, two, three, four, etc. previous adjacent tokens and next adjacent tokens may be gathered. Masked token manager 610 would have a gather previous adjacent token module (e.g., gather previous adjacent token 710-1) or gather next adjacent token module (e.g., gather next adjacent token 710-2) for each adjacent token gathered concurrently with a masked token.

Referring back to FIG. 6, token loss manager 615 is responsible for determining token losses. For instance, when token loss manager 615 receives predicted tokens for masked tokens from masked token manager 610, token loss manager 615 calculates differences (e.g., errors) between the predicted tokens and the actual values of the masked tokens (e.g., stored in label data). The calculated differences is depicted in FIG. 6 as token losses 625. Token loss manager 615 may send token losses 625 to transformer layer 110, which transformer layer 110 uses to adjust its weights.

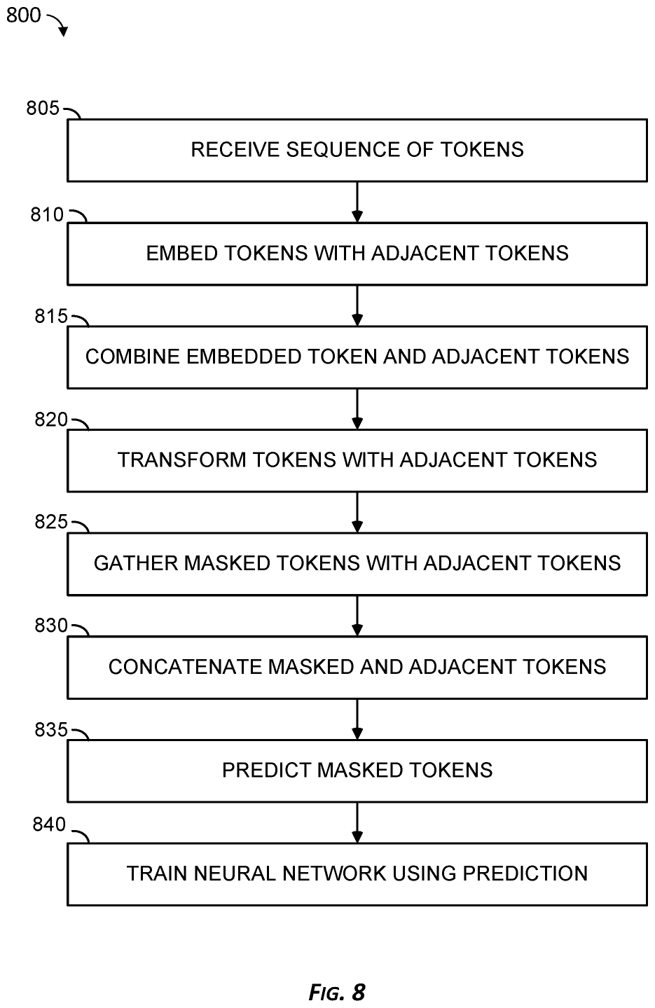

FIG. 8 illustrates process 800 for training a neural network according to some embodiments. System 100 may perform process 800. Process 800 may begin at step 805 with input data processor 105-3 receiving a set of input data for training a transformer model. The set of input data comprises a set of tokens. Some of the tokens may be masked. For example, a predetermined number (e.g., 15%) of tokens may be masked and the tokens selected for masking may be random. By way of further non-limiting example, the tokens selected for masking may have their value set to a predefined value, such as zero (0).

At step 810, an embedding layer may embed tokens with adjacent tokens. For example, an embedding layer may map a (original) token to a word in the neural network's vocabulary (e.g., ˜30,000 words) represented by a vector. Concurrently, an embedding layer may map one or more tokens adjacent to the original token. The vectors may be added together. An embedding layer may have an embedding table (e.g., token embeddings manager 1 201-1 and embedding manager 3 201-3) for each adjacent token to be concurrently mapped with the original token. As shown in FIG. 4, sentence and position embeddings may also be performed at step 810.

At step 815, an embedding layer may combine the embedded token with the adjacent tokens. For example, the tokens may be added together. The combination of tokens advantageously uses information from the tokens surrounding the original token. The original token along with the adjacent tokens create a joint probability distribution for the tokens.

At step 820, transformer layer 110 may process the tokens embedded with adjacent tokens. At step 825, masked token manager 610 may gather masked tokens along with tokens adjacent to the masked tokens from the output of transformer layer 110. For example, masked token manager 610 may identify a masked token. Masked token manager 610 may also identify one or more adjacent tokens to the masked token. Each of these tokens may be represented by a matrix.

At step 830, concatenation module 720 may concatenate the masked and adjacent tokens along the hidden dimension. In other words, the matrices are arranged side by side. At step 835, projection layer 730 generates a prediction for the masked tokens. At step 840, token loss manager 615 may use the prediction to train the neural network.

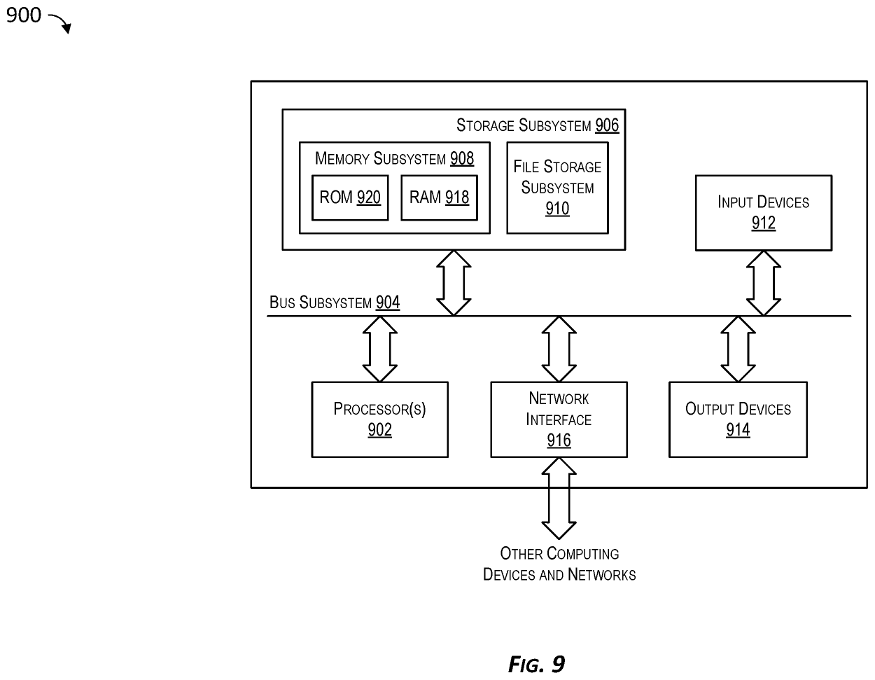

The techniques describe above may be implemented in a wide range of computer systems configured to process neural networks. FIG. 9 depicts a simplified block diagram of an example computer system 900, which can be used to implement the techniques described in the foregoing disclosure. In some embodiments, computer system 900 may be used to implement system 100. As shown in FIG. 9, computer system 900 includes one or more processors 902 that communicate with a number of peripheral devices via a bus subsystem 904. These peripheral devices may include a storage subsystem 906 (e.g., comprising a memory subsystem 908 and a file storage subsystem 910) and a network interface subsystem 916. Some computer systems may further include user interface input devices 912 and/or user interface output devices 914.

Bus subsystem 904 can provide a mechanism for letting the various components and subsystems of computer system 900 communicate with each other as intended. Although bus subsystem 904 is shown schematically as a single bus, alternative embodiments of the bus subsystem can utilize multiple busses.

Network interface subsystem 916 can serve as an interface for communicating data between computer system 900 and other computer systems or networks. Embodiments of network interface subsystem 916 can include, e.g., Ethernet, a Wi-Fi and/or cellular adapter, a modem (telephone, satellite, cable, ISDN, etc.), digital subscriber line (DSL) units, and/or the like.

Storage subsystem 906 includes a memory subsystem 908 and a file/disk storage subsystem 910. Subsystems 908 and 910 as well as other memories described herein are examples of non-transitory computer-readable storage media that can store executable program code and/or data that provide the functionality of embodiments of the present disclosure.

Memory subsystem 908 includes a number of memories including a main random access memory (RAM) 918 for storage of instructions and data during program execution and a read-only memory (ROM) 920 in which fixed instructions are stored. File storage subsystem 910 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 900 is illustrative and many other configurations having more or fewer components than system 900 are possible.

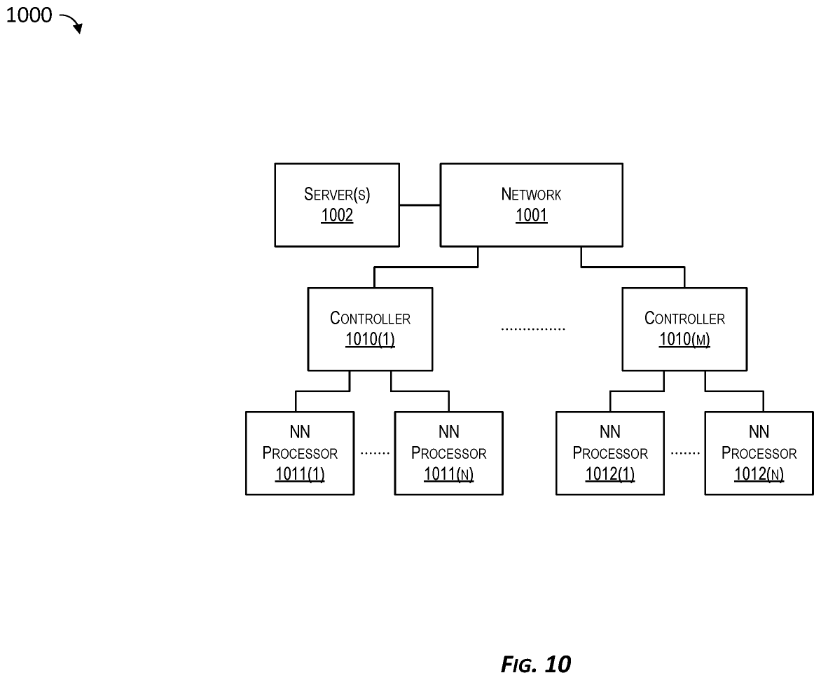

FIG. 10 illustrates a neural network processing system according to some embodiments. In various embodiments, neural networks according to the present disclosure may be implemented and trained in a hardware environment comprising one or more neural network processors. A neural network processor may refer to various graphics processing units (GPU) (e.g., a GPU for processing neural networks produced by Nvidia Corp®), field programmable gate arrays (FPGAs) (e.g., FPGAs for processing neural networks produced by Xilinx®), or a variety of application specific integrated circuits (ASICs) or neural network processors comprising hardware architectures optimized for neural network computations, for example. In this example environment, one or more servers 1002, which may comprise architectures illustrated in FIG. 9 above, may be coupled to a plurality of controllers 1010(1)-1010(M) over a communication network 1001 (e.g. switches, routers, etc.). Controllers 1010(1)-1010(M) may also comprise architectures illustrated in FIG. 9 above. Each controller 1010(1)-1010(M) may be coupled to one or more NN processors, such as processors 1011(1)-1011(N) and 1012(1)-1012(N), for example. NN processors 1011(1)-1011(N) and 1012(1)-1012(N) may include a variety of configurations of functional processing blocks and memory optimized for neural network processing, such as training or inference. The NN processors are optimized for neural network computations. Server 1002 may configure controllers 1010 with NN models as well as input data to the models, which may be loaded and executed by NN processors 1011(1)-1011(N) and 1012(1)-1012(N) in parallel, for example. Models may include layers and associated weights as described above, for example. NN processors may load the models and apply the inputs to produce output results. NN processors may also implement training algorithms described herein, for example.

### Further Example Embodiments

In various embodiments, the present disclosure includes systems, methods, and apparatuses for determining position values for training data that is used to train transformer models. The techniques described herein may be embodied in non-transitory machine-readable medium storing a program executable by a computer system, the program comprising sets of instructions for performing the techniques described herein. In some embodiments, a system includes a set of processing units and a non-transitory machine-readable medium storing instructions that when executed by at least one processing unit in the set of processing units cause the at least one processing unit to perform the techniques described above. In some embodiments, the non-transitory machine-readable medium may be memory, for example, which may be coupled to one or more controllers or one or more artificial intelligence processors, for example.

The following techniques may be embodied alone or in different combinations and may further be embodied with other techniques described herein.

For example, in one embodiment, the present disclosure includes a system comprising a set of processing units and a non-transitory machine-readable medium storing instructions that when executed by at least one processing unit in the set of processing units cause the at least one processing unit to receive a set of input data, the input data comprising a plurality of tokens, the plurality of tokens including masked tokens; process the plurality of tokens in an embedding layer, the embedding layer being coupled to a transformer layer; process the plurality of tokens in the transformer layer, the transformer layer being coupled to a classifier layer; and process the plurality of tokens in the classifier layer, the classifier layer being coupled to a loss layer, wherein one or more of the embedding layer and the classifier layer combine masked tokens at a current position with tokens at one or more of a previous position and a subsequent position.

In one embodiment, the embedding layer combines the masked tokens at the current position with tokens at one or more previous positions and tokens at one or more subsequent positions.

In one embodiment, the combining by the embedding layer comprises summing the masked tokens at the current position and the tokens at the one or more of the previous position and the subsequent position.

In one embodiment, the combining by the classifier layer comprises concatenating the masked tokens at the current position and the tokens at the one or more of the previous position and the subsequent position.

In one embodiment, the embedding layer comprises embedding tables to process in parallel masked tokens at the current position and the tokens at the one or more of the previous position and the subsequent position.

In one embodiment, the classifier layer comprises gather modules to collect in parallel the masked tokens at the current position and the tokens at the one or more of the previous position and the subsequent position.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A computer system comprising:
one or more processors; and
a non-transitory computer-readable medium storing instructions that when executed by the one or more processors causes the one or more processors to:
receive a set of input data, the input data comprising a plurality of tokens, the plurality of tokens including masked tokens;
process the plurality of tokens in an embedding layer, the embedding layer being coupled to a transformer layer;
process the plurality of tokens in the transformer layer, the transformer layer being coupled to a classifier layer; and
process the plurality of tokens in the classifier layer, the classifier layer being coupled to a loss layer,
wherein one or more of the embedding layer and the classifier layer combine masked tokens at a current position with tokens at one or more of a previous position and a subsequent position.

2. The computer system of claim 1 wherein the embedding layer combines the masked tokens at the current position with tokens at one or more previous positions and tokens at one or more subsequent positions.

3. The computer system of claim 1 wherein the classifier layer combines the masked tokens at the current position with tokens at one or more previous positions and one or more subsequent positions.

4. The computer system of claim 1 wherein the combining by the embedding layer comprises summing the masked tokens at the current position and the tokens at the one or more of the previous position and the subsequent position.

5. The computer system of claim 1 wherein the combining by the classifier layer comprises concatenating the masked tokens at the current position and the tokens at the one or more of the previous position and the subsequent position.

6. The computer system of claim 1 wherein the embedding layer comprises embedding tables to process in parallel masked tokens at the current position and the tokens at the one or more of the previous position and the subsequent position.

7. The computer system of claim 1 wherein the classifier layer comprises gather modules to collect in parallel the masked tokens at the current position and the tokens at the one or more of the previous position and the subsequent position.

8. A method comprising:
receiving a set of input data, the input data comprising a plurality of tokens, the plurality of tokens including masked tokens;
processing the plurality of tokens in an embedding layer, the embedding layer being coupled to a transformer layer;
processing the plurality of tokens in the transformer layer, the transformer layer being coupled to a classifier layer; and
processing the plurality of tokens in the classifier layer, the classifier layer being coupled to a loss layer,
wherein one or more of the embedding layer and the classifier layer combine masked tokens at a current position with tokens at one or more of a previous position and a subsequent position.

9. The method of claim 8 wherein the embedding layer combines the masked tokens at the current position with tokens at one or more previous positions and tokens at one or more subsequent positions.

10. The method of claim 8 wherein the classifier layer combines the masked tokens at the current position with tokens at one or more previous positions and one or more subsequent positions.

11. The method of claim 8 wherein the combining by the embedding layer comprises summing the masked tokens at the current position and the tokens at the one or more of the previous position and the subsequent position.

12. The method of claim 8 wherein the combining by the classifier layer comprises concatenating the masked tokens at the current position and the tokens at the one or more of the previous position and the subsequent position.

13. The method of claim 8 wherein the embedding layer comprises embedding tables to process in parallel masked tokens at the current position and the tokens at the one or more of the previous position and the subsequent position.

14. The method of claim 8 wherein the classifier layer comprises gather modules to collect in parallel the masked tokens at the current position and the tokens at the one or more of the previous position and the subsequent position.

15. A non-transitory machine-readable medium storing a program executable by at least one processing unit, the programing comprising sets of instructions for:
receiving a set of input data, the input data comprising a plurality of tokens, the plurality of tokens including masked tokens;
processing the plurality of tokens in an embedding layer, the embedding layer being coupled to a transformer layer;
processing the plurality of tokens in the transformer layer, the transformer layer being coupled to a classifier layer; and
processing the plurality of tokens in the classifier layer, the classifier layer being coupled to a loss layer,
wherein one or more of the embedding layer and the classifier layer combine masked tokens at a current position with tokens at one or more of a previous position and a subsequent position.

16. The non-transitory machine-readable medium of claim 15 wherein at least one of the embedding layer and the classifier layer combines the masked tokens at the current position with tokens at one or more previous positions and tokens at one or more subsequent positions.

17. The non-transitory machine-readable medium of claim 15 wherein the combining by the embedding layer comprises summing the masked tokens at the current position and the tokens at the one or more of the previous position and the subsequent position.

18. The non-transitory machine-readable medium of claim 15 wherein the combining by the classifier layer comprises concatenating the masked tokens at the current position and the tokens at the one or more of the previous position and the subsequent position.

19. The non-transitory machine-readable medium of claim 15 wherein the embedding layer comprises embedding tables to process in parallel masked tokens at the current position and the tokens at the one or more of the previous position and the subsequent position.

20. The non-transitory machine-readable medium of claim 15 wherein the classifier layer comprises gather modules to collect in parallel the masked tokens at the current position and the tokens at the one or more of the previous position and the subsequent position.
